(19) United States
(12) Patent Application Publication
(10) Pub. No.: US 2026/0064509 A1
(43) Pub. Date: Mar. 5, 2026

(54) METHOD AND APPARATUS FOR ERROR DETECTION IN INTEGER DATA PROCESSING

(71) Applicant: Mark P. Anderson, Hammonton, NJ (US)

(72) Inventor: Mark P. Anderson, Hammonton, NJ (US)

(21) Appl. No.: 18/822,344

(22) Filed: Sep. 2, 2024

(51) Int. Cl. G06F 11/07

(52) U.S. Cl. CPC G06F 11/0751

(57) ABSTRACT

A system and method of preventing error propagation in variables and memory, including receiving, at an arithmetic logic unit, at least one input formatted in binary according to ones complement encoding, detecting a computation error or an input error associated with the at least one input, and outputting, from the arithmetic logic unit, a binary result with ones filling all positions as a NiN value in response to detecting the computation error or the input error.

### BACKGROUND

In the 1950s, various binary representations for numbers and character sets were developed. These binary representations schemes included ones complement, twos complement, and signed magnitude. Since these different schemes required integration with the operating system, the compiler, and the processor's instruction sets, the industry quickly settled on twos complement as the encoding scheme for some reasons that now in the age of the semiconductor are rather meaningless. Indeed, twos complement has issues that can crash systems due to improper handling of variables or just the default overflow operations of twos complement. Therefore, as computer programs have gotten more complex, variable management and error detection has become far more burdensome than it was in the 1950s. Accordingly, the set of problems faced by programmers and processors today illustrates issues with twos complement as a binary representation scheme.

### SUMMARY OF THE INVENTION

The logic unit disclosed herein may detect and flag errors in computation and inputs at the lowest computational level to identify the source of such errors and reduce hidden computational errors. An integrated circuit for processing computer variables and logic, may include: a first input line from processor registers or memory, a second input line from the processor registers or memory, and at least one arithmetic logic unit (ALU). The ALU may be configured to: process commands or instructions relating to a first variable from the first input line and relating to a second variable from the second input line, the first variable and the second variable being binary representations encoded in ones complement, detect an error in computation or input, and output, based on the detected error in computation or input, a not-an-integer-number (NiN) value represented in ones complement as all ones in every binary position.

An arithmetic logic unit (ALU) may include an integrated circuit for processing ones complement binary variables, the ALU configured to: detect a computation error or an input error and output a binary result with ones filling all positions as a NiN value indicating an error.

A method of preventing error propagation in variables and memory, including: receiving, at an arithmetic logic unit (ALU), at least one input formatted in binary according to ones complement encoding, detecting a computation error or an input error associated with the at least one input, and outputting, from the arithmetic logic unit, a binary result with ones filling all positions as a NiN value in response to detecting the computation error or the input error. The detection of the computation error by the ALU may further include detecting a truncation error in a store to memory command, detecting a type conversion error, or an overflow error or underflow error based on an operation performed to the at least one input, where the computation error is a logical error or an arithmetic error.

In various implementations, the methods above may be performed by an ALU, an application specific integrated circuit (ASIC), or other integrated circuit (e.g., central processing unit—CPU). In various implementations, one or more of the ALUs described above may be incorporated into a processor or processor system so as to generate computational results individually or in combination with each other.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a table of various binary representation schemes according to an embodiment of the present disclosure.

FIG. 2 is a table of various issues with twos complement processing and a corresponding solution according to an embodiment of the present disclosure.

FIG. 3 is a table of various issues with unsigned integer representation in twos complement and a corresponding solution according to an embodiment of the present disclosure.

FIG. 4 is a table of various issues with type conversion in twos complement and a corresponding solution according to an embodiment of the present disclosure.

FIG. 5 is an arithmetic logic unit system according to an embodiment of the present disclosure.

FIG. 6 is an arithmetic logic unit system according to an embodiment of the present disclosure.

FIG. 7 is a process for error analysis and prevention according to an embodiment of the present disclosure.

### DETAILED DESCRIPTION

Various implementations will be described in detail with reference to the accompanying drawings. References made to particular examples and implementations are for illustrative purposes and are not intended to limit the scope of the claims.

The present disclosure is directed to arithmetic logic units (ALUs), and specifically to ALUs for processing ones complement arithmetic. An ALU is a crucial component of a CPU (Central Processing Unit) responsible for performing arithmetic and logical operations. It handles basic mathematical operations like addition, subtraction, multiplication, and division, as well as logical operations such as AND, OR, XOR, and NOT. The ALU receives input data from the CPU's registers or memory, processes it according to the instructions provided, and then outputs the result to registers or memory. This allows the CPU to execute complex instructions by breaking them down into simpler machine operations that the ALU then processes. The efficiency and design of the ALU significantly impact the overall speed and security of the CPU.

An ALU may receive binary numbers for processing as the input data. These binary numbers may be encoded or formatted in various ways. For example, binary representations of integer data (non-floating point data) may be encoded according to the scheme called “twos complement.” Twos complement is a method for encoding signed integers in binary, allowing for the representation of both positive and negative numbers. For positive integers, the binary representation is the same as in regular binary encoding. The most significant bit (MSB), also known as the sign bit, is 0, indicating a positive number. To represent a negative number in twos complement, the binary representation of the absolute value of the number is inverted (all 0 changed to 1 and all 1 changed to 0) and one is added to the result. To represent a negative number in ones complement, the binary representation of the absolute value if the number is simply inverted.

The most significant bit (MSB) in twos complement indicates the sign of the number and is located at the highest position in the binary representation. If the MSB is 0, the number is positive or zero; if it's 1, the number is negative. For example, negative five (5) is represented as 1111 1011 in 8-bit twos complement format. The range of numbers that may be represented in twos complement depends on the number of bits used. For n bits, the range is from −2\hat{ }(n−1) to 2\hat{ }(n−1)−1. For example, with 8 bits, you can represent numbers from −128 to 127. In other words, the range of values for any n bits in twos complement is not symmetrical about the zero. This may cause problems in the conversion between positive and negative for the highest value negative number of a binary bit representation in twos complement.

Ones complement is a method for encoding signed integers in binary, providing a way to represent both positive and negative numbers. For positive integers, the binary representation is the same as in regular binary encoding. The most significant bit (MSB) is 0, indicating a positive number. To represent a negative number in ones complement, the binary representation of the absolute value of the number is inverted for all bits (change 0 to 1 and 1 to 0). This inversion is what gives the “ones complement” of the binary number. Similar to twos complement, the most significant bit (MSB) in ones complement indicates the sign of the number. If the MSB is zero (0), the number is positive or zero; if it's one (1), the number is negative. For example, in ones complement negative five (−5) is represented as 1111 1010.

The range of numbers that can be represented in one's complement depends on the number of bits used. For n bits, the range is from −(2\hat{ }(n−1)−1) to 2\hat{ }(n−1)−1. For example, with 8 bits, you can represent numbers from −127 to 127. In other words, the range of values for any n bits in ones complement is symmetrical about the zero. Ones complement in conventional encoding has two representations for zero: positive zero where all bits are zeros (0000 0000) and negative zero where all bits are ones (1111 1111). In the past, this dual representation of zero has been considered the primary flaw of ones complement.

Nothing in the ones complement scheme, however, requires the negative zero representation (where any n bits are all ones) to represent or be used only for its mathematical value of zero. The system and method of this application instead use negative zero in the ones complement encoding to represent a not-a-integer-number (NiN) indicator. As described above, compiled code and code being executed may generate a variety of errors at the binary level. In present systems, these errors propagate without warning or any indication to the user. This can result in system faults or, even worse, incorrect results.

An ALU may be adapted to process twos complement values from registers/memory or to process ones complement values from registers/memory. In the past, computers and processors were configured to operate on either ones complement or twos complement at the ALU level, not both. For backwards compatibility with applications compiled based on twos complement, a processor may execute separate instructions for twos complement computations and ones complement computations. The processor and its ALUs may be configured to execute a first set of instructions corresponding to twos complement computations and to execute a second set of instructions corresponding to ones complement plus NiN notation computations. In this case, the full instruction set of the processor may include the standard twos complement instructions and instructions for ones complement plus NiN notation.

A software application may be coded to implement ones complement plus NiN notation and/or standard twos complement using separate variable type names. For example, in the C programming language, a twos complement integer may be instantiated with “int x” and an integer in ones complement plus NiN notation format may be instantiated with “checked int x”; thereby setting apart the variable type and encoding. The compiler may then, when compiling these different variable types, generate instructions from the different instruction sets for the different variable types. In this way, an ALU that is configured to execute both instruction sets may simply follow what the compiler has produced as an executable binary program which may contain any of these instructions and numbers encoded in either format.

In some implementations, various parts of the execution of ones complement plus NiN notation instructions may be kept separate from the standard twos complement instructions that are being executed. In one example, software applications enabled for ones complement and complying with the process disclosed herein may indicate to a processor that the values are ones complement values (e.g., by storing them in a separate CPU register). In another example, software applications enabled for ones complement and complying with the process disclosed herein may provide the ALU with instructions that are designed to operate with ones complement values or which cause the ALU to process the input data according to ones complement format. Each ALU of the processor may be configured to execute these separate sets of instructions as part of the instruction set of the processor. A processor operating according to the system and method contemplated herein may operate separate registers for ones complement values and twos complement values and each of these separate registers may feed to different ALUs. In this case, the separate instruction sets for the legacy and new software applications would operate to store values in different register areas of the processor. In any case, the programs, OSes, and functions configured to operate using ones complement with a NiN value characterized by all ones in every binary position may feed corresponding instructions and values to ALUs configured to process them.

Any compiler and/or programming language may be modified to implement checked integers in ones complement. Such implementation may include: 1) new variable types of signed and unsigned checked integer, 2) initialization to NiN of global checked integer variables that have not been initialized in the program at compile time, 3) initialization to NiN of checked integer variables that appear on the stack at function or block entry, 4) initialization of heap memory to NiN that is allocated in real-time by the program (e.g., when using malloc( ) in C), or 5) providing a new heap memory allocation function that explicitly initializes data to NiN (e.g., a new C function nalloc( )). As used in this application, checked integer means the ones complement plus NiN indicator features of integers as disclosed herein together with the checking that is done at various times to ensure valid computational results or NiN indicators for errors. As used in this application, checked integer instructions means computer instructions adapted for checked integers and for ALUs implementing checked integers and adapted for implementing any other computational aspects described herein.

Accordingly, a process and processor is disclosed that may include a first input line from processor registers or memory, a second input line from the processor registers or memory, and at least one arithmetic logic unit (ALU). The ALU may be configured to process commands or instructions relating to a first variable from the first input line and relating to a second variable from the second input line, the first variable and the second variable being binary representations encoded in ones complement, detect an error in computation or input, and output, based on the detected error in computation or input, a not-an-integer-number (NiN) value represented in ones complement as all ones in every binary position.

The ALU may be configured to detect the computation error by detecting a truncation error in a store command, detecting a type conversion error, or an overflow error or underflow error based on an operation performed to the at least one input, where the computation error is a logical error or an arithmetic error. Of course, a binary value of all ones (negative zero in ones complement) may be generated by standard computational logic, in which case, the valid negative zero result may be changed by the ALU to positive zero. The ALU may generate a computation result with a valid execution of an instruction using the at least one input, detect that the computation result is all ones in every binary position in ones complement encoding, and convert the computation result to all zeroes in every binary position which corresponds to positive zero in ones complement encoding.

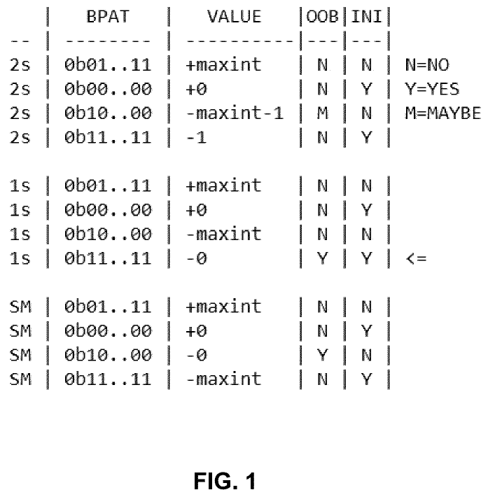

FIG. 1 shows various conventional encodings for binary including ones complement (1s), twos complement (2s), and signed magnitude (SM) as a table with various features of each encoding. These features of each encoding include a bit pattern snippet (BPAT), a corresponding value, an out-of-band indicator (OOB) for the value, and an indicator of whether the value can be used as a single byte initializer for variables of all sizes (INI). These features include various encoding differences for each of the encodings (1s, 2s, SM) including the maximum integer value, minimum integer value (maximum negative value), and encodings at the middle of the range including zero and negative one. A single byte initializer is a number that reads the same bitwise no matter how long it is. For example, if it was eight bits, it would be all the same bit value. For example, if it was 16 bits, it would be all the same bit value. Accordingly, memory may be initialized byte by byte by this pattern in order to be readily apparent when a memory space of any size has been filled by this indicator.

For twos complement, the maximum positive integer value has a bit pattern beginning with “0b01” with the rest of the bit positions filled with ones. This maximum value (127 for 8 bits) is an in-band value and is regularly used to represent values in binary. This maximum integer also cannot operate as a single byte initializer as the high bit is different (zero).

For twos complement, the zero is a positive zero and has a bit pattern of all zeros and begins with “0b00”. This value or bit representation is in-band (not OOB) and used extensively by computation logic. The value of zero may operate as a single byte initializer. For the standard C compiler, variables are sometimes initialized with zero in twos complement. Initialization with all zeros in twos complement, however, causes problems because it is an in-band number used to mean zero and so uninitialized variables often become initialized with zero and then erroneously used in computations.

For twos complement, the maximum negative integer (minimum int) has a bit pattern beginning with “0b10” and having all zeroes in the rest of the positions. Given that this binary value has no corresponding positive value, this value could be treated as out-of-band, but typically is not. This maximum negative integer also cannot operate as a single byte initializer as the high bit is different (one).

For twos complement, the nearest negative number to zero is negative one which is encoded as all ones with bit pattern starting “0b11”. Negative one (−1) is an in-band value (not OOB) that is used as part of routine operations. The value of negative one (−1) may operate as a single byte initializer since it is characterized by all ones in any bit length.

For ones complement, the maximum positive integer has a bit pattern that begins with “0b01” and continues with all ones. This value is not out-of-band (OOB) as it would be used in computations. This value is also not able to operate as a single byte initializer since the high bit is different (zero).

For ones complement, the encoding provides a negative zero and a positive zero. The positive zero in ones complement may be encoded with the bit pattern starting “0b00” and continuing with all zeroes. This value is not out-of-band since it is the zero used by most systems for mathematical zero representation. The value could be used as a single byte initializer since it is characterized by all zeroes in any bit length.

For ones complement, the maximum negative integer begins with bit pattern “0b10” and continues with all zeroes. In ones complement, the maximum negative integer corresponds to the maximum positive integer in absolute magnitude and, therefore, both are used for computation and are not OOB. This value is also not able to operate as a single byte initializer since the high bit is different (one).

For ones complement, the other zero in the conventional encoding is negative zero. Conventionally, this encoding for zero was considered an annoyance to be avoided. Conventionally, this negative zero was the primary reason for ones complement falling out of favor. The negative zero has a bit pattern beginning with “0b11” and continuing with all ones. This value may be considered out-of-band since it is redundant since it is not used mathematically because positive zero is used for this purpose. Likewise, this value is also able to be used as a single byte initializer since it is characterized by all ones in any bit length. In this application, this negative zero representation is, therefore, adopted to be used instead as a not-a-integer-number (NiN) indicator for computations instead of being used as a negative zero (or left unused).

For signed magnitude encoding, there are also maximum and minimum integers as shown that correspond to the bit encodings of maximum integer and negative zero in ones complement, respectively. Neither of these values can be used as an indicator because they are regularly used for mathematical operations. Signed magnitude encoding also has positive and negative zero like ones complement does, but in this case, the negative zero cannot operate as a single byte initiator. For these reasons and features, only negative zero in ones complement may be repurposed to function as a NiN indicator as described herein.

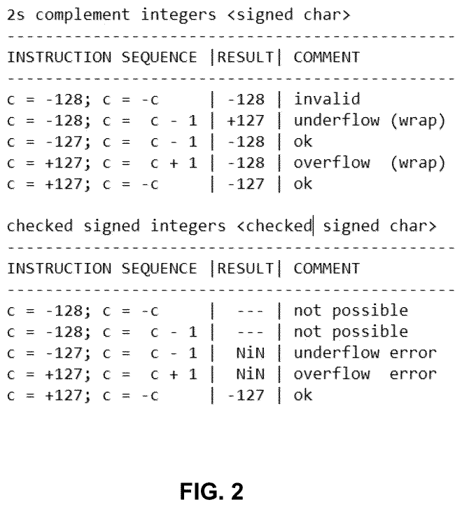

FIG. 2 illustrates computation issues with twos complement hardware representations together with checked integer encodings for the same instruction sequence. The computation results of the checked integer sequence are closer to what someone would expect from integer calculations given the finite bit size of integer variables. Specifically, when an error occurs such as an overflow or an underflow, the checked integer instruction sequence is processed by the ALU so as to result in a NiN value indicating the error. In contrast, with twos complement, an underflow that results from subtracting from maximum negative integer will “wrap” the bit sequence around to the maximum positive integer by flipping the bits. This misleads the program and the user as to the real nature of the twos complement calculation that occurred and its intended result. Likewise, with twos complement, an overflow that results from adding to the maximum positive integer will “wrap” the bit sequence around to the maximum negative integer by flipping the bits. In both cases, an ALU executing checked integer instructions that calculate this operation via ones complement would detect the wrap as an improper operation and instead produce a result of NiN which is an integer of all one bits as described above. Accordingly, the ones complement instructions using NiN as described herein solves these issues with signed integer operations.

The checked hardware instructions disclosed in this application operate on data encoded in ones complement. As described above, for backwards compatibility, existing twos complement instructions may be retained so that an ALU may process those as well. This results in a larger instruction set that includes the legacy instructions and the secure checked integer instructions. If backwards compatibility is not needed, then the standard ALU instructions may be replaced by checked integer instructions that implement ones complement plus NiN indicators. As described later, the hardware (e.g., ALUs) may be modified to ensure that −0 is not exposed to users, i.e., valid results of −0 are first converted to +0 before exiting the ALU. In any case, valid mathematical results of checked arithmetic instructions that give −0 may be changed to +0 so as to reserve −0 for NiN (error) indication. Checked integer instructions with invalid results may produce NiN as a result at the ALU. Any checked integer instruction with NiN as an input may produce NiN as the result to ensure the error indication propagates. In addition, by using ones complement for all instructions in the secure checked integer instruction set, any problems associated with converting and promoting between legacy twos complement instructions and checked integer representations can be avoided by avoiding mixed mode expressions computations. The C programming language specification levies no requirements on integer representations and does say that sign magnitude, ones complement, and twos complement are equally valid. The C programming language specification, however, does not suggest an implementation that includes both integer representations (i.e., ones complement and twos complement) nor does the C specification suggest using the negative zero of ones complement as a NiN error indicator.

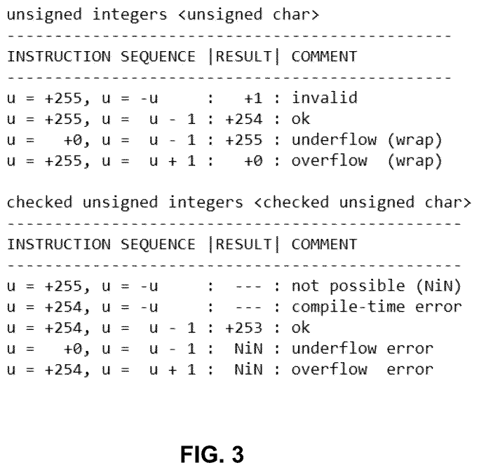

FIG. 3 illustrates computation issues with twos complement representations together with checked integer encodings for the same unsigned integer instruction sequence. Note that with reference to FIGS. 2, 3 and 4, integer variables and character variables may be interchangeable or operated on by instructions in a similar manner. In FIG. 2, a legacy unsigned integer of 8 bits (or unsigned char) may have a value range of zero to +255. Because the integer variable is unsigned, an attempt to make the variable negative will be invalid. Subtraction from the maximum integer value (e.g., +255 for 8 bits) on legacy twos complement is acceptable and results in +254. However, a subtraction from the minimum unsigned integer value will result in an underflow and a wrap to the maximum integer value, which can cause computation problems as noted with respect to signed integers above. Likewise, an addition of one (or more) to the maximum unsigned integer value (e.g., 255 for 8 bits) may result in an overflow and a wrap to the minimum unsigned integer value (e.g., 0). As with signed integers and explained regarding FIG. 2, these integer or character (or long, short, etc.) operations that result in wrapping can cause hidden problems.

For the implementation of unsigned integers of any size (8/16/32/64 bits) in ones complement with NiN as described herein, the value or bit pattern of all ones in all positions of the variable is reserved for the NiN indicator. For unsigned integers, the NiN value of all ones in every position has a value of +225 in 8 bits. In this case, the NiN value uses an in-band number of +255. Accordingly, in the instant implementation of unsigned variable types (char, int, etc.), the max value is one less than the legacy unsigned integer value range so that the maximum value with all ones may represent a NiN indicator. In this implementation, the NiN indicator for unsigned variables may also operate as a single byte initiator.

As shown in FIG. 3, the assignment of +255 to the checked unsigned 8 bit integer variable “u” is not possible as that value is retained for NiN. A value of +254 may be assigned to “u” as shown, which would be the maximum integer value for checked unsigned integers of 8 bits, for example. In the checked integer instructions, making the maximum integer value a negative is not allowed (as with the legacy operation) and in the instant implementation would be caught at compilation as a compiler error. Likewise, subtracting one (1) from the maximum checked unsigned integer value is an acceptable operation (e.g., resulting in +253)—as are many other common mathematical operations (e.g., DIV).

In an implementation, a checked unsigned integer may be set to zero and an instruction may attempt to subtract a value (e.g., 1) from the zero value of checked unsigned integer variable “u”. Such an operation would be executed by an ALU that is configured to execute checked integer instructions and would result in a NiN indicator as an output. The ALU may detect the underflow produced by subtracting from zero and may output a NiN indicator or interrupt to alert the larger system (e.g., CPU). In an implementation, a checked unsigned integer may be set to the maximum integer value of +254 for 8 bits and an instruction may attempt to add a value of one (1) or more to this maximum integer value. The ALU that is configured to execute checked integer instructions may receive the maximum integer value and the instruction and the value (1) and may detect that an overflow has occurred due to the checked instruction (or that the requested increment is not available). The ALU may then output a NiN indicator as a result of the checked instruction or output an interrupt to alert the larger system.

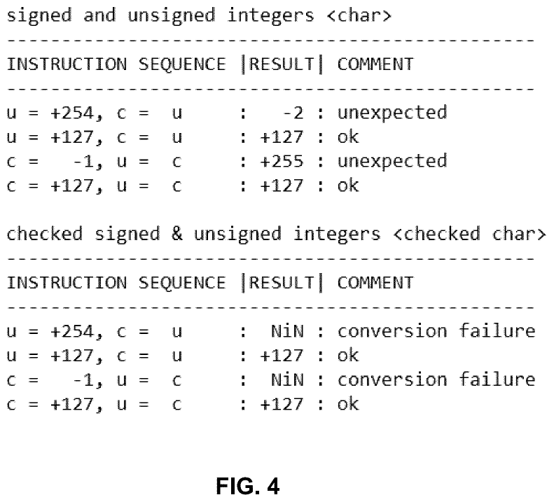

FIG. 4 illustrates a table of various issues with type conversion in twos complement as well as a corresponding instruction sequence for checked integers. These issues with type conversion may involve signed and unsigned integers and character conversions. In conventional twos complement and the C programming language, an integer type “int” may be stored in integer type “char” and a “char” may be stored in an “int”. Such an instruction sequence or operation involves a variable type conversion (i.e., char, short, int, etc. are referred to as variable types). The “char” variable, for example, may be encoded according to the American Standard Code for Information Interchange (ASCII) standard. These type conversions can result in unexpected results.

For example, where an “unsigned int” variable “u” is set to 254 and then stored in a “signed char” variable, the result in legacy twos complement is negative two (−2), which is an unexpected and unusable result. An “unsigned int” that is given the value 127 and then stored or converted to “signed char” may become the integer value 127, which is an appropriate conversion. This conversion is also reversible as shown in the last line of the table section for twos complement. In another example, a “signed char” may be set to negative one (−1) and then may be stored or converted to an “unsigned int” which would result in the integer value of 255 which is an unexpected and unusable result. As with the other issues with twos complement processing, these unexpected results may be propagated through a series of operations or computations and be treated as expected or nominal results.

The added checked integer instructions may operate on checked integers via ALUs configured to process these instructions and integers. Checked integer instructions may generate a NiN indicator as a result for any error condition, may generate a NiN output if any of the inputs were a NiN indicator, and may convert any legitimate −0 result to +0 (for signed integers). Accordingly, neither the processor (e.g., CPU) nor the software will receive or process legitimate −0 values as required by conventional ones complement arithmetic processes.

An ALU implementing checked integer instructions as described herein may check for incoming NiN values and produce NiN results according to prescribed rules and failure modes. The ALU or another system of the CPU may be instructed to produce an interrupt if a NiN result is produced via a checked integer instruction in a compatible ALU. The checked integer instructions may include modified load and store instructions that are NiN-aware and that are configured to cause an ALU to detect input NiN indicators as well as generate NiN indicators when an improper operation is performed. When loading from memory (i.e., load instruction) with optional sign extension, an ALU may detect NiN values and may cause an interrupt. When storing sub-word values to memory (i.e., the least significant 8 bits or 16 bits from a 32b register) (e.g., storing 8b: 0×23 from 0×00000123), an ALU executing a checked integer instruction (e.g., checked STORE) may check for truncation and store a NiN indicator instead and, optionally, cause an interrupt.

Conventionally, a STORE instruction that stores least significant bits (LSBs) may blindly truncate by taking the lower-order bits and disregarding the values of the higher-order (upper) bits. A truncation via a checked unsigned STORE instruction of LSBs where the upper bits are not zero may indicate an unexpected truncation or an improper truncation. A truncation via a checked signed STORE instruction of LSBs where the higher-order bits are not all identical to the sign bit (most significant bit or MSB) of the lower-order bits being stored may indicate an unexpected truncation or an improper truncation. An ALU may be configured to execute a checked STORE instruction that may detect values in the non-truncated bits (i.e., remaining, non-LSB bits) and may store a NiN indicator if inappropriate values are detected in the remaining bits.

In an implementation of the checked integer instruction set and ones complement plus NiN indicators, these conversion failures (e.g., improper “int” to “char” or “char” to “int”) may be flagged by the ALU executing the instruction (e.g., checked STORE). The ALU may then replace the unexpected and incorrect value with the NiN value as described herein (i.e., all ones in every position). The bottom four rows of the table of FIG. 4 list examples of appropriate conversions and inappropriate conversions which may be replaced with NiN indicators/values when output from the ALU.

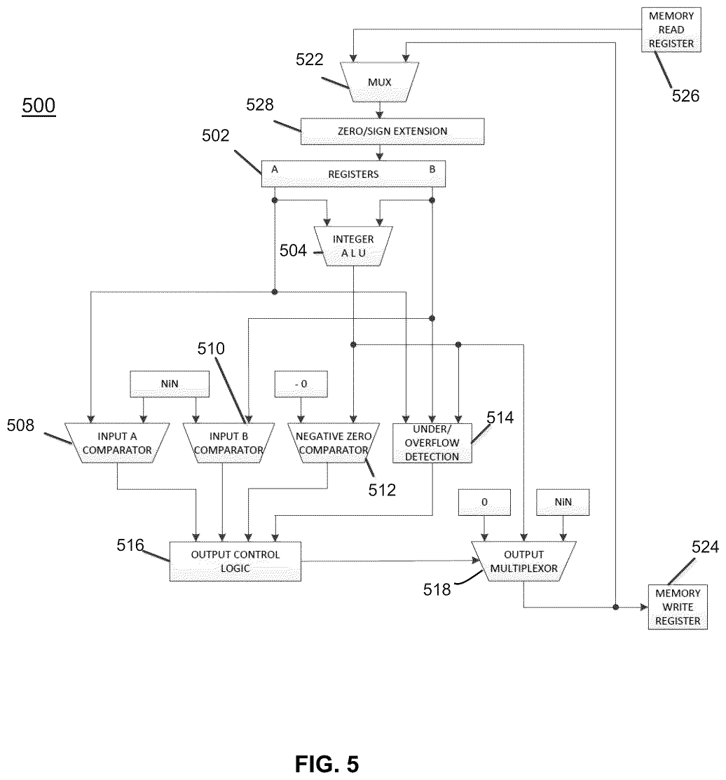

In FIG. 5, an ALU system 500 is illustrated with various hardware logic components that are configured to perform mathematical logic corresponding to the instructions described herein. The registers 502 may be CPU registers or memory registers (e.g., random access memory) for storing variables, data, and instructions. For example, the registers 502 may include an execution stack of the processor. The registers 502 may be hardware blocks of memory or cache that for example may be sized as 64 bit or 32 bit or 16 bit or 8 bit, as the case may be, and depending on the configuration of the CPU. Two variables (A and B) from registers 502 may be output to the integer ALU 504.

The ALU 504 may implement the binary math that corresponds to the received instruction. The binary math may use the two variables and may output a binary result which may include errors as described above including overflow, underflow, wrapping, out of range addition/subtraction (e.g., add 1 to unsigned integer value of 255 of 8 bits). The integer ALU 504 may also output a carry flag, an overflow flag, a sign flag, a NiN flag, or other flags indicating issues that may have occurred during computation. The integer ALU 504 may output to the negative zero comparator 512 which may compare the valid result of the ALU math or logic to determine if the binary value output of the integer ALU 504 is equal to negative zero. The negative zero comparator 512 may output true/false (i.e., a Boolean result) to output control logic 516 as to whether the input is equal to negative zero or not, which may include a comparison with negative zero as another input to the comparator.

The value or variable A which is read from the registers 502 may be compared in input A comparator 508 with a NiN value to determine whether the input to the ALU was a NiN. An input NiN value may indicate an error in a prior calculation of the ALU or another ALU configured in this way and may be treated as a binary value by the integer ALU 504. To ensure the error indicator (NiN) is propagated through the series of calculations, the input A comparator 508 may output true/false to the output control logic 516 to indicate whether the input was a NiN value so that the output control logic 516 may take action and replace the ALU result at the output multiplexor 518.

Likewise, the value or variable B which is read from the registers 502 may be compared in input B comparator 510 with a NiN value to determine whether the input to the ALU was a NiN. The input B comparator 510 may output true/false to the output control logic 516 to indicate whether the input B was a NiN value so that the output control logic 516 may take action and replace the ALU result at the output multiplexor 518. The integer ALU 504 may output to the output multiplexor 518 and may output one or more indicator flags to the output control logic 516 (e.g., carry flag). The output control logic 516 may determine if any of the true/false inputs from the input A/B comparators 508/510 are true and may instruct the output multiplexor 518 to select the NiN input as the output of the ALU system 500 (if true).

The output control logic 516 may determine if the negative zero comparator 512 has output a true or false and, if true, may instruct the output multiplexor 518 to select the zero input as the output of the ALU system 500 (i.e., converting the −0 to +0 at the output multiplexor 518). The output control logic 516 may determine if the under/overflow detection 514 has output a true or false and, if true, may instruct the output multiplexor 518 to select the NiN input as the output of the ALU system 500. Accordingly, the output control logic 516 may operate as a selector for the output multiplexor 518 which may select from inputs zero, NiN, and the ALU output binary value based on the selector from the output control logic 516.

The underflow/overflow detection 514 may receive the original input A and the original input B from the registers 502 as well as the result from the integer ALU 504. The underflow/overflow detection 514 may then determine based on the inputs A/B whether the output is an unexpected or an incorrect value. The underflow/overflow detection 514 may output a single true/false since in either case (under flow or over flow being true) the action by the output control logic 516 may be the same: selecting NiN for output. The selected output of the output multiplexor 518 may be stored in memory write register 524 or may be returned to registers 502 via the input multiplexor (MUX) 522 and the zero/sign extension component 528.

Values from the ALU system 500 may be written to memory write register 524 of an external memory using a subsequent store command. Further, variables and values for input to the integer ALU 504 may be retrieved from the memory read register 526 with a memory load command, for example. The input multiplexor (MUX) 522 may select between inputs from the output multiplexor 518 and the memory read register 526. For example, a value may be read from memory read register 526 and selected by the input multiplexor (MUX) 522 for transfer to register A of the registers 502. For example, a value may be read from output multiplexor 518 and selected by the input multiplexor (MUX) 522 for transfer to register B of the registers 502.

The zero/sign extension component 528 may receive values of various bit sizes and may resize the received values into a standard bit size stored by the registers 502. The bits of an input may be extended for an unsigned variable by adding upper bits with zeros to fill out the full bit space (e.g., 32 bit). For example, an unsigned variable of 8 bits with a value of 6 may be extended to 32 bits in the zero/sign extension component 528 by adding 24 bits of upper bits with values of zero above the top most bit of the input 8 bit variable. This enables the integer ALU to operate on variables of a single bit size.

The zero/sign extension component 528 may receive a signed value variable with a MSB that indicates a sign (positive/negative) of the number. The zero/sign extension component 528 may extend the bits of the received variable to the length required by the registers 502 and may copy or replicate the MSB sign bit of the shorter received variable into the longer output variable. Both the input variable and the output variable have the same value, only the bit length is changed.

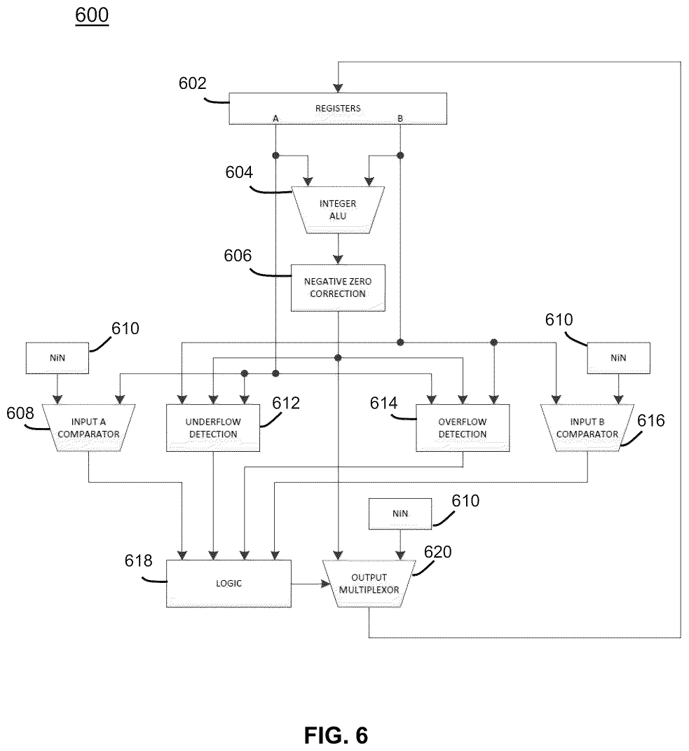

FIG. 6 illustrates an ALU system 600 with various hardware logic components that are configured to perform mathematical logic corresponding to the instructions described herein. Registers 602 may store two or more variables such as variable A and variable B. A variable pair from registers 602 (e.g., variables A/B) may be input into the integer ALU 604, which may execute an instruction that operates on the variable pair. The result of the mathematical operation in the integer ALU 604 may be output to the negative zero correction component 606. The negative zero correction component 606 may detect whether the output of the integer ALU 604 is a negative zero as a result of valid math in ones complement. If the output of the integer ALU 604 is a negative zero, then the negative zero correction component 606 may convert the negative zero to positive zero since the negative zero value in ones complement is reserved for NiN indicators.

As with the ALU system 600, the inputs of variables A and B may be also input to the input comparators, input A comparator 608 and input B comparator 616. The input A comparator 608 and input B comparator 616 may compare the respective input variables to the NiN value 610 (i.e., all ones in all positions of the binary sequence) and may output a true/false result indicating whether the input variable (A/B) is a NiN value (i.e., true for NiN input). The input A comparator 608 and input B comparator 616 may output to the logic block 618 which may instruct the output multiplexor 620 to select NiN 610 as an output rather than the output of the integer ALU 606.

The corrected output of the integer ALU 604 may be checked for an overflow condition in the mathematical operation that operated on the variables A and B. The overflow detection component 614 may receive the variables A and B and the corrected output of the integer ALU 604 and may check whether an overflow occurred in the computation of the result that was received. The overflow detection component 614 may determine whether the computation result of the integer ALU is unexpected or incorrect. The overflow detection component 614 may output a true or false to the logic block 618 that indicates whether an overflow occurred or not. The underflow detection component 612 may receive the variables A and B and the corrected output of the integer ALU 604 and may check whether an underflow occurred in the computation of the result that was received. The underflow detection component 612 may determine whether the computation result of the integer ALU is unexpected or incorrect. The underflow detection component 612 may output a true or false to the logic block 618 that indicates whether an underflow occurred or not.

The logic block 618 may receive the true/false outputs of the input A comparator 608, input B comparator 616, the overflow detection component 614, and the underflow detection component 612. If any of these true/false inputs (Boolean inputs) from any of these components is a true (indicating a NiN value input to the integer ALU or an overflow/underflow), then the logic block 618 may instruct the output multiplexor 620 to output the NiN indictor 610. If all the inputs to the logic block 618 that are associated with a particular computation (e.g., using A/B) are false, then the logic block 618 may instruct the output multiplexor 620 to output the corrected ALU result. In any case, the output of the output multiplexor 620, whether the NiN indicator 610 or the corrected ALU result, may be output to registers 602 for storage and further processing. The output multiplexor 620 may output to external memory as well. The ALU system 500 and ALU system 600 are example implementations and may be adapted differently so long as the ALU results may be checked for the issues noted herein and execute the CPU instructions (e.g., checked integer instructions) as described herein.

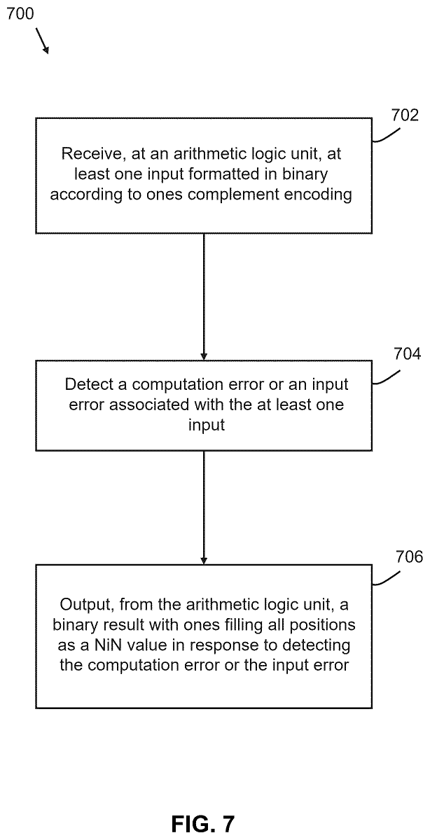

FIG. 7 illustrates a process executing operations on ones complement binary data and detect and flag errors in those operations. Any of the components of FIGS. 5-6 may be operated to perform this process 700. Further, any of the instructions described for ones complement in FIGS. 2-4 may command the components of FIGS. 5-6 to execute logic that performs ones complement arithmetic and flags errors using a NiN indicator of all ones in every position in ones complement.

In block 702, the processor and ALU system may receive, at an arithmetic logic unit, at least one input formatted in binary according to ones complement encoding. The processor and ALU may further receive at least one further input; and output, from the arithmetic logic unit, a binary result formatted according to twos complement based on the at least one further input. The at least one input may include a computer instruction selected from a first set of instructions executable by the arithmetic logic unit, the first set of instructions configured to operate on ones complement. The at least one further input may include a computer instruction selected from a second set of instructions executable by the arithmetic logic unit, the second set of instructions configured to operate on twos complement, the first set of instructions being different from the second set of instructions.

The processor and ALU system may further receive a checked signed sub-word data STORE instruction and a register input. The processor and ALU system may further receive a checked unsigned sub-word data STORE instruction and a register input. The at least one input and the at least one further input may be a NiN indicator which may indicate that an error has occurred previously in a chain of instructions.

In block 704, the processor and ALU system may detect a computation error or an input error associated with the at least one input. Detecting the computation error may include detecting a truncation error in a checked STORE command, detecting a type conversion error, or an overflow error or underflow error based on an operation performed to the at least one input, where the computation error is a logical error or an arithmetic error. Detecting the computation error may include detecting that an arithmetic command results in a wrapping of the binary number that is mathematically incorrect.

The processor and ALU system may detect a sign bit of a checked signed integer sub-word being stored (due to a truncating store command) that does not match all upper bits of a remaining portion of the register input not being stored, which may indicate a computation error. The processor and ALU system may detect that remaining upper bits of the register input of a checked unsigned integer sub-word being stored that are not being stored (due to a truncating store command) are not all zeros, which may indicate a computation error.

In block 706, the processor and ALU system may output, from the arithmetic logic unit, a binary result with ones filling all positions as a NiN value in response to detecting the computation error or the input error. The NiN value may be output in response to detecting the computation error. The NiN value may correspond to a negative zero value represented in ones complement. The at least one input may be a NiN value indicating an input error or prior error, and the output of the binary result as a NiN value may be performed in response to detecting the input error.

The processor and ALU system may generate a valid computational result with a valid execution of an instruction using the at least one input, detect that the valid computational result is all ones in every binary position in ones complement encoding, and convert the valid computational result to all zeroes in every binary position which corresponds to positive zero in ones complement encoding. This may allow the NiN value to be reserved for error indication. The processor and ALU system may output a NiN value to a memory storage subsystem to indicate a truncation error at a memory location instructed by the signed sub-word data store instruction based on detecting the truncation error in block 704. The processor and ALU system may output a NiN value to a memory storage subsystem to indicate a truncation error at a memory location instructed by the unsigned sub-word data store instruction based on detecting the truncation error in block 704.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit for processing computer variables and logic, comprising:
a first input line from processor registers or memory;
a second input line from the processor registers or memory; and
at least one arithmetic logic unit configured to:
process commands or instructions relating to a first variable from the first input line and relating to a second variable from the second input line, the first variable and the second variable being binary representations encoded in ones complement;
detect an error in computation or input; and
output, based on the detected error in computation or input, a not-an-integer-number (NiN) value represented in ones complement as all ones in every binary position.

2. The integrated circuit of claim 1, wherein the at least one arithmetic logic unit is configured to detect an error in computation or input by detecting that at least part of the input including the first variable and the second variable is the NiN value.

3. The integrated circuit of claim 1, wherein the NiN value corresponds to a negative zero value represented in ones complement which is a binary variable having all ones in every binary position.

4. The integrated circuit of claim 1, wherein the at least one arithmetic logic unit is configured to detect an error in computation or input by detecting an overflow error or underflow error, and wherein the at least one arithmetic logic unit is configured to output the NiN value.

5. The integrated circuit of claim 1, wherein the at least one arithmetic logic unit is configured to detect an error in computation or input by detecting a type conversion error, and wherein the at least one arithmetic logic unit is configured to output the NiN value.

6. The integrated circuit of claim 5, wherein the first variable from the first input line and the second variable from the second input line are error free.

7. The integrated circuit of claim 1, wherein the at least one arithmetic logic unit is configured to detect an error in computation or input by detecting a NiN input.

8. The integrated circuit of claim 7, wherein the NiN input indicates an uninitialized variable or a prior error in a prior computation being propagated forward.

9. The integrated circuit of claim 1, the at least one arithmetic logic unit further configured to:
generate a computation result with a valid execution of an instruction using the first variable from the first input line and the second variable from the second input line;
detect that the computation result is all ones in every binary position in ones complement encoding; and
convert the computation result to all zeroes in every binary position which corresponds to positive zero in ones complement encoding.

10. An arithmetic logic unit, comprising:
an integrated circuit for processing ones complement binary variables, configured to:
detect a computation error or an input error; and
output a binary result with ones filling all positions as a NiN value indicating an error.

11. A method of preventing error propagation in variables and memory, comprising:
receiving, at an arithmetic logic unit, at least one input formatted in binary according to ones complement encoding;
detecting a computation error or an input error associated with the at least one input; and
outputting, from the arithmetic logic unit, a binary result with ones filling all positions as a NiN value in response to detecting the computation error or the input error.

12. The method of claim 11, wherein detecting the computation error further comprises:
detecting a truncation error in a store command;
detecting a type conversion error; or
an overflow error or underflow error based on an operation performed to the at least one input,
wherein the computation error is a logical error or an arithmetic error.

13. The method of claim 11, wherein the NiN value is output in response to detecting the computation error.

14. The method of claim 11, wherein the NiN value corresponds to a negative zero value represented in ones complement.

15. The method of claim 11, further comprising:
receiving at least one further input; and
outputting, from the arithmetic logic unit, a binary result formatted according to twos complement based on the at least one further input,
wherein the at least one input includes a computer instruction selected from a first set of instructions executable by the arithmetic logic unit, the first set of instructions configured to operate on ones complement, and
wherein the at least one further input includes a computer instruction selected from a second set of instructions executable by the arithmetic logic unit, the second set of instructions configured to operate on twos complement, the first set of instructions being different from the second set of instructions.

16. The method of claim 11, wherein the at least one input is a NiN value indicating an input error or prior error, and wherein the outputting the binary result as a NiN value is performed in response to detecting the input error.

17. The method of claim 11, wherein detecting the computation error further comprises:
detecting that an arithmetic command results in a wrapping of the binary number that is mathematically incorrect.

18. The method of claim 11, further comprising:
generating a valid computational result with a valid execution of an instruction using the at least one input;
detecting that the valid computational result is all ones in every binary position in ones complement encoding; and
converting the valid computational result to all zeroes in every binary position which corresponds to positive zero in ones complement encoding.

19. The method of claim 11, further comprising:
receiving a signed sub-word data store instruction and a register input;
detecting a sign bit of a sub-word being stored that does not match all upper bits of a remaining portion of the register input not being stored; and
outputting a NiN value to a memory storage subsystem to indicate a truncation error at a memory location instructed by the signed sub-word data store instruction.

20. The method of claim 11, further comprising:
receiving an unsigned sub-word data store instruction and a register input;
detecting that remaining upper bits of the register input that are not being stored are not all zeros; and
outputting a NiN value to a memory storage subsystem to indicate a truncation error at a memory location instructed by the unsigned sub-word data store instruction.
